(19) United States
(12) Patent Application Publication
(10) Pub. No.: US 2005/0124332 A1
(43) Pub. Date: Jun. 9, 2005

(54) Mobile device programming system and method

(76) Inventors: David R. Clark, Kitchener (CA); Nathan Marion, Raleigh, NC (US)

Correspondence Address: Paul E. Franz, Esq.;Jones Day, 901 Lakeside Avenue/North Point, Cleveland, OH, 44114, US

(21) Appl. No.: 10/786,961

(22) Filed: Feb. 25, 2004

Related U.S. Application Data
(60) Provisional application No. 60/527,952, filed on Dec. 8, 2003.

(51) Int. Cl. H04M 3/00; H04Q 7/20

(52) U.S. Cl. 455/419; 455/418

(57) ABSTRACT

A method of updating a mobile device includes receiving at a mobile device resource requirements data for an update from an update management computing device, determining whether the mobile device has associated update resources to meet the resource requirements, allocating update resources to the mobile device if the mobile device does not have update resources to meet the resource requirements, transmitting from the mobile device to the update management computing device update request data requesting update data, and receiving at the mobile device the update data from the update management computing device in response to the transmitted update request data.

This application claims the benefit of priority to U.S. Provisional Application Ser. No. 60/527,952, filed Dec. 8, 2003, the entire disclosure of which is incorporated herein by reference.

### BACKGROUND

1. Technical Field

This application relates to over-the-air (OTA) programming or updating of software and/or firmware in mobile communication devices.

2. Description of the Related Art

A mobile communication device, such as a cellular phone or wireless Internet appliance, may be programmed or updated over a wireless communication network. Update data, such as a software patch to a mobile device program, a virus protection file or an update to existing virus protection software on the mobile device, or a new program not currently loaded on the mobile device, is typically transmitted over a wireless communication network and received by the mobile device. Upon receiving the update data, the mobile device attempts to update its associated software or firmware with the update data. If the mobile device is able to receive the update data and the update operation is successful, then the mobile device operates normally.

If the update operation is unsuccessful, however, then the mobile device may not operate properly. An update may be unsuccessful for a variety of reasons. First, the mobile device may not have adequate update resources, such as available memory, to receive the update data and perform the update. The mobile device may thus not receive the update data. If the update data included a software patch to fix a software error, then the mobile device may continue to operate subject to the software error. The user of the mobile device may thus be forced to choose between deleting information stored in the mobile device memory to make available mobile device memory to receive the update data and perform the update, or continuing operation of the mobile device subject to the existing software or firmware errors.

Second, the update data may be corrupted during the transmission over the communication network, and the mobile device software or firmware may thereafter be corrupted after the mobile device attempts to update its software or firmware, severely limiting the operation of the mobile device, or even rendering the mobile device inoperable. The user may then be unable to revert back to the original mobile device configuration due to the corrupted software or firmware.

Third, even if the mobile device is updated successfully, the user may have additional software loaded on the mobile device, such as software provided by a third party, which may be incompatible with the update. Alternatively, the update may provide software or firmware enhancements that the user does not desire. In such a situation, the user may not be able to readily revert back to the original mobile device configuration.

### SUMMARY

A method of updating a mobile device includes receiving at a mobile device resource requirements data for an update from an update management computing device, determining whether the mobile device has associated update resources to meet the resource requirements, and allocating update resources to the mobile device if the mobile device does not have update resources to meet the resource requirements. The method also includes transmitting from the mobile device to the update management computing device update request data requesting update data, and receiving at the mobile device the update data from the update management computing device in response to the transmitted update request data.

Another method of updating a mobile device includes transmitting from an update management computing device to a mobile device resource requirements data for an update, receiving at the update management computing device an update request transmitted from the mobile device in response to the transmitted resource requirements data, and transmitting from the update management computing device to the mobile device the update data in response to the update request.

### BRIEF DESCRIPTION OF THE DRAWINGS

FIG. 1 is a block diagram of a system for programming a mobile device over a communication network;

FIG. 2 is a flow chart illustrating a process of evaluating a mobile device update in an allocated update resource in the mobile device;

FIG. 3 is a flow chart illustrating a process for updating a mobile device in an update management system;

FIG. 4 is a flow chart illustrating a process of allocating update resources in a mobile device;

FIG. 5 is a flow chart illustrating a process of determining whether a pending updated mobile device configuration is to be evaluated or accepted during a mobile device initialization;

FIG. 6 is a functional diagram of another embodiment of a system for programming a mobile device over a communication network; and

FIG. 7 is a block diagram of an exemplary mobile communication device.

### DETAILED DESCRIPTION

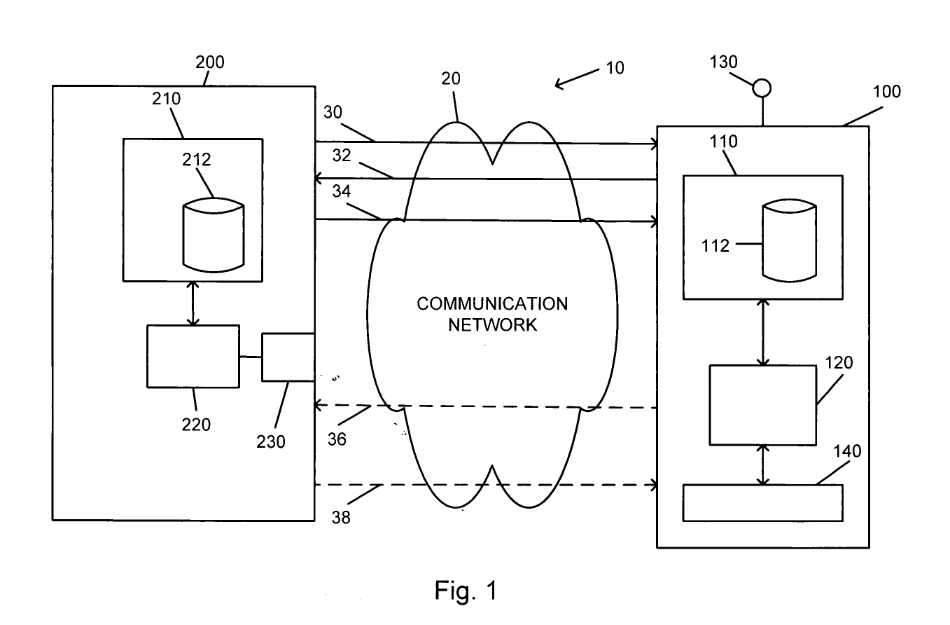

FIG. 1 is a block diagram of a system 10 for programming a mobile device 100 over a communication network 20. The system 10 includes an update server 200 operable to send data to and receive data from the mobile device 100 over the communication network 20.

The mobile device 100 may be a computing device operable to send and receive data over the communication network 20. Exemplary mobile devices include cellular telephones, pagers, wireless enabled personal digital assistants (PDA's), and other such voice and data communication devices. The mobile device 100 comprises a memory subsystem 110, a processing subsystem 120, a communication subsystem 130, and an input/output subsystem 140. The processing subsystem 120 is coupled to the memory subsystem 110 and the communication subsystem 130, and is operable to store and retrieve data in the memory subsystem 120 and execute instructions stored in the memory subsystem 120, and to cause the communication subsystem 130 to transmit and receive data over the communication network 20. The memory subsystem 110 may store mobile device data 112 associated with one or more programs or software executed on the processing subsystem 120. One such exemplary mobile device 100 may be of the type disclosed in U.S. Pat. No. 6,278,442, entitled “HAND-HELD ELECTRONIC DEVICE WITH A KEYBOARD OPTIMIZED FOR USE WITH THE THUMBS,” the entire disclosure of which is incorporated herein by reference.

The communication network 20 over which the mobile device 100 communicates may be a wireless communication network, such as a cellular network or satellite based communication network, or may be a combination of wire/fiber based networks and wireless networks, such as the Internet and a cellular network in communication with the Internet over a wireless gateway. The mobile device 100 may be able to receive voice communications and/or data communications over the communication network 20. For example, the mobile device 100 may comprise a mobile station operable to receive redirected e-mail messages over a wireless network. One such exemplary mobile device redirector system may be of the type disclosed in U.S. Pat. No. 6,219,694, entitled “SYSTEM AND METHOD FOR PUSHING INFORMATION FROM A HOST SYSTEM TO A MOBILE DATA COMMUNICATION DEVICE HAVING A SHARED ELECTRONIC ADDRESS,” the entire disclosure of which is incorporated herein by reference.

The update server 200 comprises a memory subsystem 210, a processing subsystem 220, and a communication subsystem 230. The processing subsystem 220 is coupled to the memory subsystem 210 and the communication subsystem 230, and is operable to store and retrieve data in the memory subsystem 220 and execute instructions stored in the memory subsystem 220, and to cause the communication subsystem 230 to transmit and receive data over the communication network 20. The memory subsystem 210 may store update data 212 associated with one or more updates for the mobile device 100. The update server 200 may comprise a single server computer, or may be a distributed computing system distributed over a network, such as several computers distributed over a local area network (LAN).

The update data 212 may comprise data related to one or more mobile device configuration updates, such as an operating system software update, an application software update, a firmware update for one or more mobile device subsystems, or even a data file update, such as a data file for a virus protection program. Other mobile device configuration updates may also be accommodated by the update data 212. The update data 212 may be in the form of a self-executing software patch or self-extracting file, or may be an executable program that requires a user command to perform an update to the mobile device configuration. Processing the update data 212 at the mobile device 100 updates the mobile device 100 from a baseline configuration to an updated configuration.

In operation, the update server 200 sends an update notification to the mobile device 100. Alternatively, the mobile device 100 may periodically poll the update server 200 to determine if the current mobile device configuration has a pending update, and the update server 200 may then send the update notification to the mobile device 100.

If an update for the current mobile device configuration is available, the update server 200 transmits resource requirements data to the mobile device 200, as shown by transmission 30. The resource requirements data may be transmitted as part of the update notification if the update server 200 is configured to automatically provide updates to the mobile device 100 as the updates become available, or may alternatively be provided in response to the periodic poll of the update server 200 by the mobile device 100.

The resource requirements data specifies the minimum update resources to be associated with the mobile device 100 for the update to be performed. The resource requirements typically specify a minimum amount of available memory in the memory subsystem 110 of the mobile device 100. For example, if the update data comprises a 64 KB compressed file that will extract to 100 KB when decompressed, then the memory subsystem 110 must have 100 KB of available memory. Additionally, if the update further requires an additional 50 KB of memory for various update operations, such as data swapping, then the resource requirements will specify that the mobile device 100 must have 150 KB of available memory in the memory subsystem 110. Other resource requirements may also be specified, such as a minimum mobile device configuration (e.g., a minimum operating system level), a minimum amount of computational resources (e.g., a minimum processing capability), and the like.

Upon receiving the resource requirements data, the mobile device 100 will determine whether it has associated resources to meet the specified resource requirements. If the mobile device 100 does not have associated resources to meet the specified resource requirements, then the mobile device 100 will obtain the necessary resources. The necessary resources may be obtained solely by the mobile device 100, or by the mobile device 100 in cooperation with another processing system, such as the update server 200. For example, if a resource requirement specifies a minimum amount of available memory, then the necessary resources may be obtained by deleting or purging data stored in the mobile device memory subsystem 110 to make available the required amount of available memory. Alternatively, the data identified to be purged may be transmitted to the update server 200, or some other storage device for temporary storage, and then deleted from the memory subsystem 110 of the mobile device 100 to make available the required amount of available memory. After the update is completed, the stored data is then transmitted back to the mobile device 100 and stored in the memory subsystem 110.

After obtaining the update resources, the mobile device 100 will transmit to the update server 200 an update request to request that the update data 212 be transmitted to the mobile device 100, as shown by transmission 32. In response to the update request, the update server 200 will transmit the update data 212 to the mobile device 100, as shown by transmission 34. Upon receiving the update data 212, the mobile device 100 will process the update data 212 and create an updated mobile device configuration.

After the updated mobile device configuration is created, the user of the mobile device 100 may accept the update, or revert back to the original baseline mobile device configuration. In one embodiment, all modifications to the mobile device 100 in the updated mobile device configuration are stored in a specified update resource. For example, if 150 KB of available memory is required for an update, then 150 KB of memory in the mobile device 100 is made available. All modifications to the baseline mobile device configuration are made within the specified available memory while the baseline mobile device configuration remains unchanged in the remaining memory. Thus, after an update is made to the baseline mobile device configuration, the mobile device 100 has two selectable configurations—the original baseline configuration, and the updated mobile device configuration.

The user of the mobile device 100 may then test the mobile device 100 using the updated configuration and choose to accept the updated configuration or revert back to the baseline configuration. If the user chooses to select the updated configuration, then the baseline configuration of the mobile device 100 is set to the updated configuration. In one embodiment, data in the allocated update memory are copied over data in the remaining mobile device memory 110, and the allocated update memory is then deallocated. In another embodiment, corresponding data in the remaining mobile device memory 110 is purged and the updated data in the allocated memory is referenced in place of the purged corresponding data. Any mobile device data stored in an external storage device, such as the update server 200, is then transmitted back to the mobile device 100 and stored in the memory subsystem 110. Other methods of setting the baseline configuration of the mobile device 100 to the updated configuration may also be used.

If the user of the mobile device 100 chooses to revert back to the baseline configuration, then the allocated memory is deallocated. Any mobile device data stored in an external storage device, such as the update server 200, is then transmitted back to the mobile device 100 and stored in the memory subsystem 110.

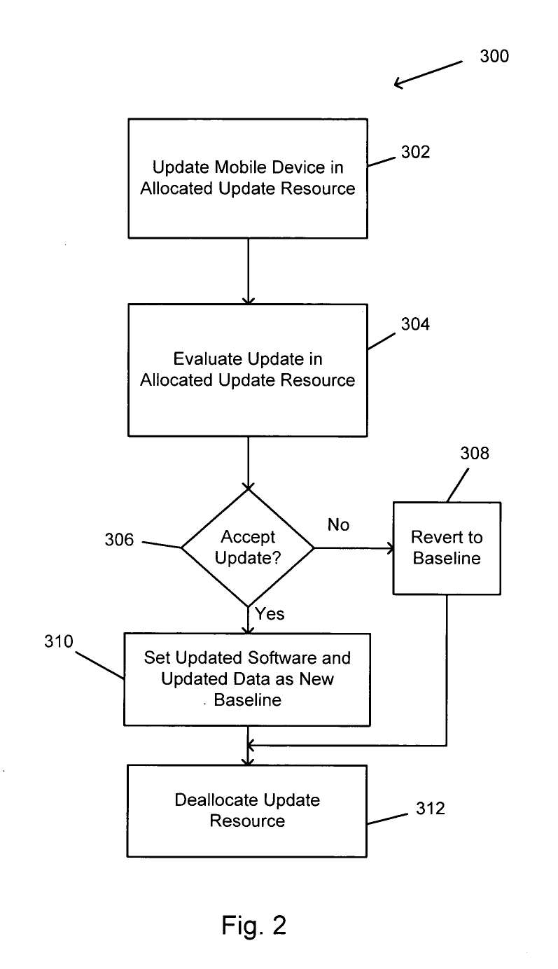

FIG. 2 is a flow chart 300 illustrating a process of evaluating a mobile device update in an allocated update resource in the mobile device 100. As described above, an allocated update resource may comprise a portion of the mobile device memory subsystem 110. In step 302, the mobile device 100 is updated in the allocated update resource. For example, all changes to a baseline mobile device configuration may be limited to the memory of the mobile device allocated for the update process. Thus, after execution of step 302, the mobile device 100 has two selectable configurations—the original baseline configuration, and the updated mobile device configuration. Because all changes to the baseline configuration are contained within the memory of the mobile device 100 allocated for the update process, the baseline configuration of the mobile device 100 is unchanged. Retention of the baseline configuration facilitates a reversion to the baseline configuration with minimum processing steps, as described below.

In step 304, the mobile device 100 is evaluated in the allocated update resource. For example, the mobile device 100 may temporarily execute in the updated mobile device configuration, the data of which is stored in the memory allocated for the update process. Thus, if a mobile device application data file is updated, then the mobile device 100 executes the application and references the updated data file stored in the memory allocated for the update process. During the evaluation, the original data file is still stored in the mobile device 100 memory subsystem 110, but is not accessed.

Likewise, if a mobile device application is updated, then the mobile device 100 executes the updated application stored in the memory allocated for the update process. During the evaluation, the original application is still stored in the mobile device 100 memory subsystem 110, but is not accessed. Data that are manipulated by the updated application may be copied into the memory allocated for the update process prior to execution of the updated application.

Alternatively, in another embodiment, the data that are manipulated during the update may be copied into the memory allocated for the update process as needed, according to a “copy-on-write” technique. The copy-on-write technique involves copying only data that are updated as the data are updated, and retaining references to unchanged data, where possible. This allows a very efficient use of memory resources when updating data or data files.

In step 306, the user chooses whether to accept the update. If the user chooses not to accept the update, then in step 308 the mobile device 100 reverts to the baseline configuration. The mobile device 100 may revert to the baseline configuration by clearing the memory allocated for the update process, or by any other method by which the baseline configuration may be restored.

If the user chooses to accept the update, however, then in step 310 the mobile device 100 sets the updated configuration as the new baseline configuration. In one embodiment, data in the allocated update memory are copied over data in the remaining mobile device memory 110. In another embodiment, corresponding data in the remaining mobile device memory 110 is purged and the updated data in the allocated memory is referenced. Other methods by which the baseline configuration of the mobile device 100 may be set to the updated configuration may also be used.

In step 312, allocated update resources are deallocated. This step may include purging data from the memory allocated for the update process in the mobile device 100 and enabling normal read and write operations to the memory. Additionally, if data were transferred from the mobile device 100 to an external storage device, step 312 may also include requesting and receiving the stored data from the external storage device and storing the data in the memory subsystem 110 of the mobile device 100.

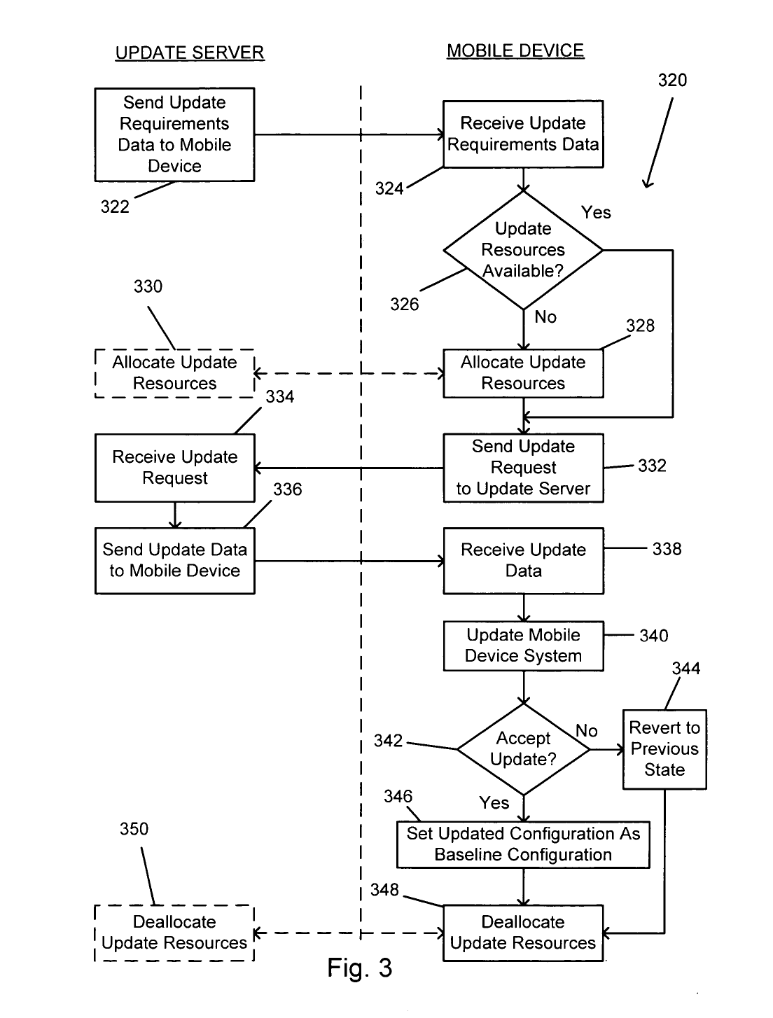

FIG. 3 is a flow chart 320 illustrating a process for updating a mobile device 100 in an update management system. The update management system may comprise the mobile device 100 and the update server 200. In another embodiment, the update server 200 may comprise a plurality of computing devices in communication with the mobile device 100. Each of the plurality of computing devices may have allocated update functions that are performed at one or more occurrences during the update process.

In step 322, the update server sends update requirements data to the mobile device 100. The update requirements data may be sent to the mobile device 100 as part of a scheduled update notification to the mobile device 100, or in response to a periodic poll from the mobile device 100, or in response to some other condition that, when met, results in the update server 200 sending the update requirements data to the mobile device 100. The update requirements data typically specifies one or more update resource requirements, such as a memory requirement, processing requirement, or some other requirement. For example, a memory requirement may specify a minimum amount of memory to execute an update process on the mobile device 100. A processing requirement may specify a minimum amount of processing capability to execute the update process. Other requirements may include a minimum communication requirement, such as a bandwidth requirement for data swapping during execution of the update process.

In step 324, the mobile device 100 receives the update requirements data, and in step 326 determines whether update resources are available at the mobile device 100. If one or more update resources are not available, then in step 328 the mobile device 100 allocates the required update resources. The resources may be allocated solely by the mobile device 100, or by the mobile device 100 in cooperation with another processing system, such as the update server 200, as indicated by step 330. For example, if a resource requirement specifies a minimum amount of available memory, then the necessary resources may be obtained by deleting or purging data stored in the mobile device memory subsystem 110 to make available the required amount of available memory. If the purged data is stored in another storage system in communication with the mobile device 100, such as a contact database stored on a mail server, then the stored data may be downloaded to the mobile device 100 after the update process is complete.

Alternatively, the data to be purged to make available the required amount of available memory may be transmitted to the update server 200, or some other storage device, for temporary storage, and then purged from the memory subsystem 110 of the mobile device 100 to make available the required amount of available memory.

Likewise, if the resource requirement specifies a minimum processing capability and the mobile device 100 does not meet the minimum processing capability, or if the resource requirement specifies that the update server 200 is to perform update operations on stored mobile device data, then data stored in the memory subsystem 110 of the mobile device 100 may be transmitted to the update server 200. Thus, if a mobile device update requires processor intensive operations, such as re-indexing a stored database, the processor intensive operations may be performed by update server 200, which typically has much more processing capability than the mobile device 100.

Once the resource requirements are obtained, or if the mobile device 100 already has the necessary resource requirements, then in step 332 the mobile device 100 sends an update data request to the update server 200. In step 334, the update server 200 receives the update data request, and in response sends the update data to the mobile device in step 336.

The update data may comprise data related to one or more mobile device configuration updates, such as an operating system software update, an application software update, a firmware update for one or more mobile device subsystems, or even a data file update, such as a data file for a virus protection program. Other mobile device configuration updates may also be accommodated by the update data. The update data may be in the form of a self-executing software patch or self-extracting file, or may be an executable program that requires a user command to perform an update to the mobile device configuration.

The mobile device 100 receives the update data in step 338, and in step 340 the mobile device 100 is updated. In step 342, the user of the mobile device 100 determines whether to accept the update. If the user chooses not to accept the update, then in step 344 the mobile device 100 reverts to the baseline configuration. If the user chooses to accept the update, however, then in step 346 the mobile device 100 sets the updated configuration as the new baseline configuration. In step 348, the update resources are deallocated. Likewise, any allocated update resources in the update server are also deallocated in step 350. Step 350 typically includes sending stored mobile device data or updated mobile device data back to the mobile device 100 for storage in the mobile device memory subsystem 110.

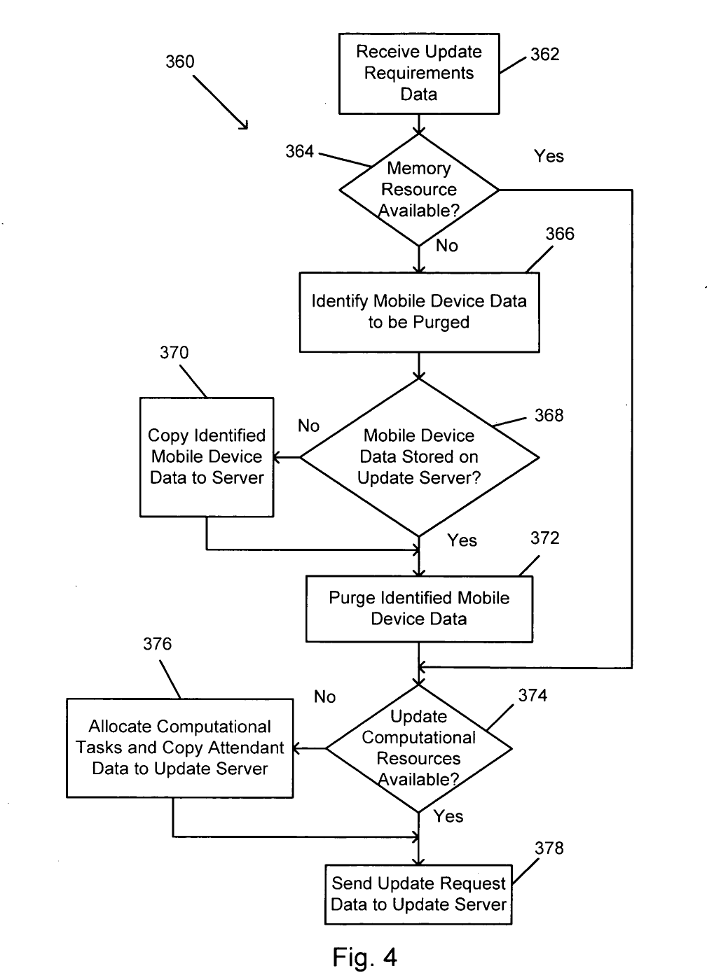

FIG. 4 is a flow chart 360 illustrating a process of allocating update resources in a mobile device 100. Update resources are allocated in response to update requirements data that specifies one or more update resource requirements, such as a memory requirement, processing requirement, or some other requirement. In the flow chart 360 of FIG. 4, the update requirements data specifies a memory resource and a computational resource.

In step 362, the update requirements data are received by the mobile device 100. In step 364, the mobile device 100 determines whether it has a minimum amount of memory available to meet the specified memory requirement. If the mobile device 100 determines that it does not have the minimum amount of memory available to meet the specified memory requirement, then in step 366 it identifies mobile device data stored in the memory subsystem 110 to be purged to make available the specified minimum amount of memory.

In step 368, the mobile device 100 determines if the identified mobile device data to be purged is stored on the update server 200. If the identified mobile device data to be purged is not stored on the update server 200, then the mobile device 100 may transmit the identified mobile device data to be purged to the update server 200, as shown in step 370. In step 372, the identified mobile device data is purged, making available at least the minimum amount of memory to meet the specified memory requirement.

In another embodiment, the mobile device 100 may determine whether the identified mobile device data to be purged is stored on some other external storage device. For example, if the identified data to be purged is a collection of e-mail messages, then the mobile device may determine whether the e-mail messages are stored on an associated mail server. If so, then the e-mail messages may be purged without sending the e-mail messages to the update server 200 or the mail server. Instead, after the update process is complete, the purged e-mail messages may be downloaded to the mobile device 100 from the mail server.

Alternatively, the purged data need not be replaced if the mobile device 100 can operate without such data. For example, if a collection of e-mail messages is purged, then the e-mail messages need not be replaced after the update process.

In step 374, the mobile device 100 determines whether it has a minimum amount of update computational resources available to meet the specified memory requirement. A computational resource may be included as an update resource requirement so as to minimize the amount of time required to perform the update at the mobile device 100. The computational resources may specify a processor type, update computational requirements, or some other resource type. For example, a computational resource may specify a minimum processor speed or minimum processor instruction set size.

Alternatively, the computational resource may specify a maximum file alteration size, e.g., a maximum size of a database file that may be re-indexed at the mobile device 100 as a result of an update. Thus, if a database file stored on the mobile device 100 that is to be updated exceeds the maximum specified size, the database may be transmitted to the update server 200, which may have additional computational resources and thus re-index the database file relatively quickly as compared to the mobile device 100. The updated data are then transmitted back to the mobile device 100 after the update is performed.

In another embodiment, the update requirements may specify that particular data files or applications to be updated be transmitted to the update server 200. For example, if it would be more efficient to update a particular data file at the update server 200, then the particular data file is transmitted to the update server 200.

If the mobile device 100 does not have the specified computational resource, then corresponding computational tasks are allocated to the update server 200, and attendant data are sent to the update server 200 to be updated, as shown in step 376.

Having obtained the necessary update resource requirements, the mobile device 100 sends update request data to the update server 200, as shown in step 378. Upon receiving the update request data, the update server 200 sends update data to the mobile device 200, and/or performs any associated computational tasks allocated in step 376.

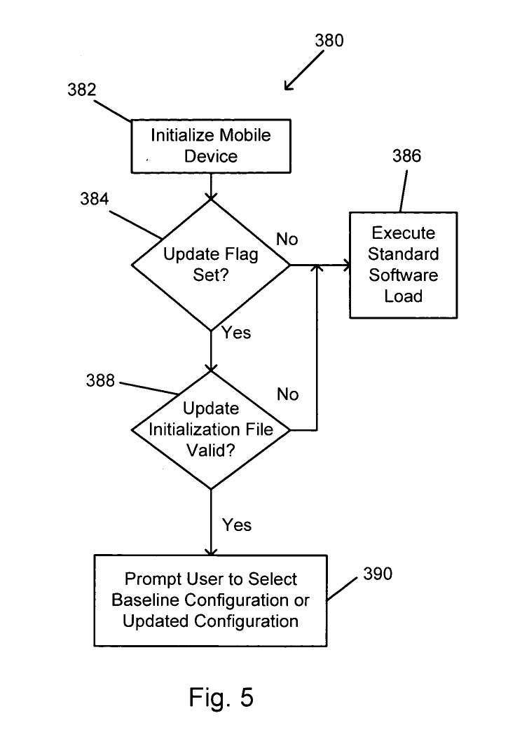

After the update is performed, updated data in the mobile device 100 are stored in the memory allocated for the update process. The user of the mobile device 100 may accept the update, or revert back to the baseline configuration of the mobile device 100, as described with reference to FIG. 3 above. If the update data are corrupted during the transmission over the communication network 20, however, then the mobile device 100 software or firmware may thereafter be corrupted after the mobile device 100 attempts to update its software or firmware. Such corruption may render the mobile device 100 inoperable, and the user may then be unable to revert back to the original mobile device configuration when restarting the mobile device 100. To prevent such a condition, an update initialization file indicating a pending update may be stored on the mobile device 100 as part of the update process. FIG. 5 provides a flow chart 380 illustrating a process of determining whether a pending updated mobile device configuration is to be evaluated or accepted during an initialization of a mobile device 100.

In step 382, the mobile device 100 is initialized. The mobile device 100 may be initialized as part of a normal power-on or restart procedure. In step 384, the mobile device 100 determines during the initialization whether an update flag is set. If an update flag is not set, then a standard software load is executed in step 386. A standard software load typically includes initializing the mobile device 100 according to a baseline configuration.

If an update flag is set, however, then an update initialization file is checked to determine whether valid update data is specified in the file. Such valid update data may include an identification of a baseline mobile device configuration and an updated mobile device configuration. If an update initialization file does not exist, or is corrupted, then a standard software load is executed in step 386.

If an update initialization file does exist and is valid, however, then the user is prompted to select the baseline configuration of the mobile device 100 or the updated configuration of the mobile device 100, as shown in step 390. The mobile device 100 is then loaded according to the selected configuration, and the baseline configuration of the mobile device 100 is set to the selected configuration. In another embodiment, however, the user may again test the updated mobile device configuration before selecting one of the baseline configurations or the updated configuration.

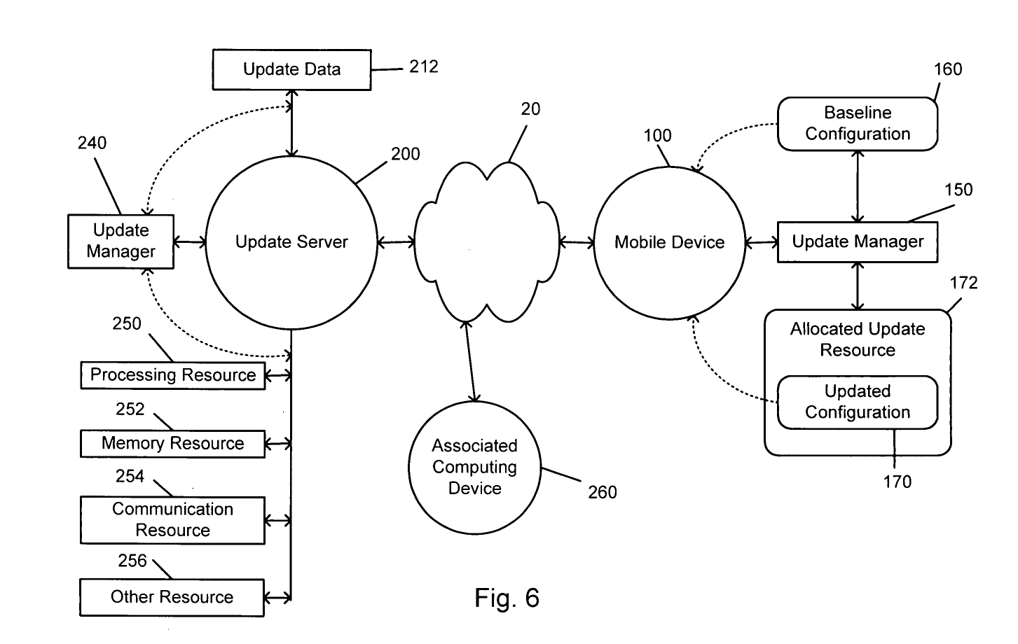

FIG. 6 is a functional diagram of another embodiment of a system for programming a mobile device 100 over a communication network 20. The structures to perform the associated functions comprise the mobile device 100 including update manager programming 150, and an update server 200 including update manager programming 240. Each update manager program 150 and 240 comprises instructions executable by the processing subsystems of the mobile device 100 and the update server 200. The instructions are operable to cause the mobile device 100 and the update server 200 to perform some or all of the functions, steps and processes described with respect to FIGS. 1-5, and are stored in a computer readable medium accessible by either the mobile device 100 or update server 200. The update managers 150 and 240 may be implemented as stand-alone programs, or may be embedded instructions in application software or system software running on the mobile device 100 and the update server 200.

The update manager 150 comprises instructions that, when executed, manage the update process for updating the mobile device 100 at the mobile device 100. For example, the update manager 150 may comprise instructions to send and receive the update data messages described with reference to FIGS. 1-6 above, and to maintain the baseline configuration 160 of the mobile device 100 while also maintaining the updated configuration 170 in the allocated update resource 172. Additionally, the update manager 150 may also manage the reversion back to the baseline configuration 160 or the acceptance of the updated configuration 170.

Likewise, the update manager 240 comprises instructions that, when executed, manage the update process for updating the mobile device 100 at the update server 200. For example, the update manager 240 may comprise instructions to send and receive the update data messages described with reference to FIGS. 1-6 above, and to manage the allocation of various update resources, such as processing resources 250, memory resources 252, communication resources 254, or other resources 256.

Additionally, the update managers 150 and 240 may also manage the allocation of update resources with an associated computing device 260. For example, if the associated computing device 260 is a mail server, then the update manager 150 may upload any contacts that are stored on the mobile device 100 and not stored on the mail server 260 before the update process.

Similarly, the associated computing device 260 may be used as an additional processing resource. For example, either of the update managers 150 or 240 may instruct the associated computing device 260 to perform computations on mobile device data to create updated data that is then provided to the mobile device 100 for storage. By way of another example, if the associated computing device 260 is a server maintained by a third party software vendor, then the update manager 240 may utilize the high bandwidth connection of the update server 200 as a communication resource 254 to communicate with the associated computing device 260 to obtain update data 212 or to have the associated computing device 260 perform one or more proprietary processes on mobile device data to be updated. The update data 212 or updated mobile device data are then provided to the mobile device 100.

The systems and methods described in this application may also be adapted for use in updating computing devices over other communication networks. For example, the update management system of FIGS. 1-6 may also be adapted for updating a client computer in communication with the update server 200 over a communication network such as the Internet, a LAN, a WAN, or other such communication networks. Thus, if the associated computing device 260 is a redirector computing device 260 that is operable to redirect e-mail messages sent to a mail server to the mobile device 100, then the update server 200 may also update the redirector computing device 260 in a similar manner as described with respect to the mobile device 100.

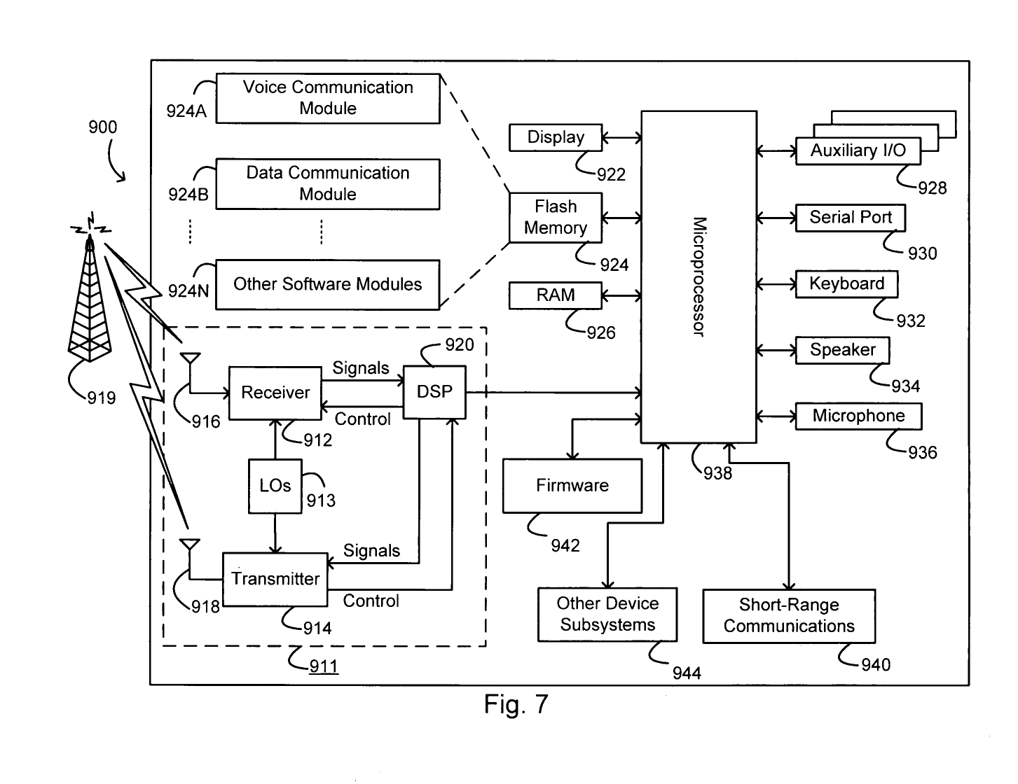

FIG. 7 is a block diagram of an exemplary mobile communication device 900 in which the systems and methods disclosed herein may be implemented. The wireless device 900 is preferably a two-way communication device having voice and/or data communication capabilities. The voice communications may be implemented over either an analog or digital voice communication channel. The device preferably has the capability to communicate with other computer systems on the Internet. Depending on the functionality provided by the device, the device may be referred to as a data messaging device, a two-way pager, a cellular telephone with data messaging capabilities, a wireless Internet appliance or a data communication device (with or without telephony capabilities).

Where the device 900 is enabled for two-way communications, the device will incorporate a communication subsystem 911, including a receiver 912, a transmitter 914, and associated components such as one or more, preferably embedded or internal, antenna elements 916 and 918, local oscillators (LOs) 913, and a processing module such as a digital signal processor (DSP) 920. The particular design of the communication subsystem 911 will be dependent upon the communication network in which the device is intended to operate. For example, a device 900 may include a communication subsystem 911 designed to operate within a Mobitex mobile communication system, a DataTAC mobile communication system, or a General Packet Radio Service (GPRS) communication subsystem 911.

Network access requirements will also vary depending upon the type of network 919. For example, in the Mobitex and DataTAC networks, mobile devices such as 900 are registered on the network using a unique personal identification number or PIN associated with each device. In GPRS networks, however, network access is associated with a subscriber or user of a device 900. A GPRS device, therefore, requires a subscriber identity module (not shown), commonly referred to as a SIM card, in order to operate on a GPRS network. Without a SIM card, a GPRS device will not be fully functional. Local or non-network communication functions (if any) may be operable, but the device 900 will be unable to carry out any functions involving communications over network 919. When required network registration or activation procedures have been completed, a device 900 may send and receive communication signals over the network 919. Signals received by the antenna 916 through a communication network 919 are input to the receiver 912, which may perform such common receiver functions as signal amplification, frequency down conversion, filtering, channel selection and the like, and in the example system shown in FIG. 7, analog to digital conversion. Analog to digital conversion of a received signal allows more complex communication functions, such as demodulation and decoding, to be performed in the DSP 920. In a similar manner, signals to be transmitted are processed, including modulation and encoding, for example, by the DSP 920 and input to the transmitter 914 for digital to analog conversion, frequency up conversion, filtering, amplification and transmission over the communication network 919 via the antenna 918.

The DSP 920 not only processes communication signals, but also provides for receiver and transmitter control. For example, the gains applied to communication signals in the receiver 912 and transmitter 914 may be adaptively controlled through automatic gain control algorithms implemented in the DSP 920.

The device 900 preferably includes a microprocessor 938, which controls the overall operation of the device. Communication functions, including at least data and voice communications, are performed through the communication subsystem 911. The microprocessor 938 also interacts with further device subsystems, such as the display 922, flash memory 924, random access memory (RAM) 926, auxiliary input/output (I/O) subsystems 928, serial port 930, keyboard 932, speaker 934, microphone 936, a short-range communications subsystem 940, a power subsystem, and any other device subsystems generally designated as 944.

Some of the subsystems shown in FIG. 7 perform communication-related functions, whereas other subsystems may provide “resident” or on-device functions. Notably, some subsystems, such as keyboard 932 and display 922, for example, may be used for both communication-related functions, such as entering a text message for transmission over a communication network and device-resident functions such as a calculator or task list.

Operating system software used by the microprocessor 938 is preferably stored in a persistent store such as flash memory 924, which may instead be a read only memory (ROM) or similar storage element. The operating system, specific device applications, or parts thereof, may be temporarily loaded into a volatile store such as RAM 926. Received communication signals may also be stored to RAM 926. Flash memory 924 preferably includes data communication module 924B, and when device 900 is enabled for voice communication, a voice communication module 924A. Also included in flash memory 924 are other software modules 924N. In particular, mobile device update management and allocation software may be implemented in a software module, such as software module 924N.

The microprocessor 938, in addition to its operating system functions, preferably enables execution of software applications on the device. A predetermined set of applications that control basic device operations, including at least data and voice communication applications, for example, will normally be installed on the device 900 during manufacture. A preferred application that may be loaded onto the device may be a personal information manager (PIM) application having the ability to organize and manage data items relating to the device user, such as, but not limited to, e-mail, calendar events, voice mails, appointments, and task items. Naturally, one or more memory stores would be available on the device to facilitate storage of PIM data items on the device. Such PIM applications would preferably have the ability to send and receive data items via the wireless network. In a preferred embodiment, the PIM data items are seamlessly integrated, synchronized and updated, via the wireless network, with the device user's corresponding data items stored or associated with a host computer system.

Further applications may also be loaded onto the device 900 through the network 919, an auxiliary I/O subsystem 928, serial port 930, short-range communications subsystem 940 or any other suitable subsystem 944, and installed by a user in the RAM 926 or a non-volatile store for execution by the microprocessor 938. Such flexibility in application installation increases the functionality of the device and may provide enhanced on-device functions, communication-related functions, or both. For example, secure communication applications may enable electronic commerce functions and other such financial transactions to be performed using the device 900.

In a data communication mode, a received signal such as a text message or web page download will be processed by the communication subsystem 911 and input to the microprocessor 938, which will preferably further process the received signal for output to the display 922, or alternatively, to an auxiliary I/O device 928. A user of device 900 may also compose data items, such as e-mail messages, for example, using the keyboard 932, which is preferably a complete alphanumeric keyboard or telephone-type keypad, in conjunction with the display 922 and possibly an auxiliary I/O device 928. Such composed items may then be transmitted over a communication network through the communication subsystem 911.

For voice communications, overall operation of the device 900 is substantially similar, except that received signals would preferably be output to a speaker 934 and signals for transmission would be generated by a microphone 936. Alternative voice or audio I/O subsystems, such as a voice message recording subsystem, may also be implemented on the device 900. Although voice or audio signal output is preferably accomplished primarily through the speaker 934, the display 922 may also be used to provide an indication of the identity of a calling party, the duration of a voice call, or other voice call related information, for example.

The serial port 930 would normally be implemented in a personal digital assistant (PDA)-type communication device for which synchronization with a user's desktop computer (not shown) may be desirable, but is an optional device component. Such a port 930 would enable a user to set preferences through an external device or software application and would extend the capabilities of the device by providing for information or software downloads to the device 900 other than through a wireless communication network. The alternate download path may, for example, be used to load an encryption key onto the device through a direct and thus reliable and trusted connection to thereby enable secure device communication.

Additional subsystems may also be included. For example, firmware 942 may include one or more programs or instructions for operation of the mobile device 900. The firmware 942 may be updated periodically as needed, such as by the OTA updating process described above.

A short-range communications subsystem 940 is a further optional component which may provide for communication between the device 900 and different systems or devices, which need not necessarily be similar devices. For example, the subsystem 940 may include an infrared device and associated circuits and components or a BluetoothTM communication module to provide for communication with similarly-enabled systems and devices.

This written description uses illustrative embodiments to disclose the invention, including the best mode, and also to enable a person of ordinary skill in the art to make and use the invention. Other embodiments and devices are within the scope of the claims if they have elements that do not differ from the literal language of the claims or have elements equivalent to those recited in the claims.

1. A method of updating a mobile device, comprising:
receiving at a mobile device resource requirements data for an update from an update management computing device;
determining whether the mobile device has associated update resources to meet the resource requirements;
allocating update resources to the mobile device if the mobile device does not have associated update resources to meet the resource requirements;
transmitting from the mobile device to the update management computing device update request data requesting update data; and
receiving at the mobile device the update data from the update management computing device in response to the transmitted update request data.

2. The method of claim 1, wherein determining whether the mobile device has associated update resources to meet the resource requirements comprises determining whether the mobile device has a minimum amount of available memory in a mobile device memory.

3. The method of claim 2, wherein allocating update resources to the mobile device if the mobile device does not have associated update resources to meet the resource requirements comprises:
upon determining that the mobile device does not have the minimum amount of available memory, identifying stored mobile device data stored in the mobile device memory that may be purged to make available the minimum amount of available memory in the mobile device memory.

4. The method of claim 3, wherein allocating update resources to the mobile device if the mobile device does not have associated update resources to meet the resource requirements further comprises:
upon identifying stored mobile device data stored in the mobile device memory that may be purged to make available the minimum amount of available memory in the mobile device memory:
determining whether the identified stored mobile device data is stored on a remote storage device operable to communicate with the mobile device over a communication network;
upon determining that the identified stored mobile device data is not stored on the remote storage device, transmitting the identified stored mobile device data to the remote storage device for storage; and
purging the identified stored mobile device data from the mobile device memory.

5. The method of claim 4, further comprising:
updating the mobile device with the received update data;
transmitting a request from the mobile device to the remote storage device for transmission of the identified stored mobile device data from the remote storage device to the mobile device;
receiving the identified stored mobile device data from the remote storage device in response to the transmitted request; and
storing the identified stored mobile device data in the mobile device memory.

6. The method of claim 5, wherein the remote storage device comprises the update management computing device.

7. The method of claim 5, wherein updating the mobile device with the received update data comprises:
determining a baseline mobile device configuration;
creating an updated mobile device configuration within the available memory of the mobile device; and
maintaining the baseline mobile device configuration after creating the updated mobile device configuration within the available memory of the mobile device.

8. The method of claim 7, wherein updating the mobile device with the received update data further comprises:
determining whether to accept the updated mobile device configuration;
upon determining to accept the updated mobile device configuration, accepting the updated mobile device configuration as the mobile device baseline; and
upon determining not to accept the updated mobile device configuration, reverting to the baseline mobile device configuration.

9. The method of claim 7, wherein updating the mobile device with the received update data further comprises:
storing an update resource in the mobile device memory, the update resource specifying the baseline mobile device configuration and updated mobile device configuration;
determining whether an update resource is stored in the mobile device memory during an initialization of the mobile device;
upon determining that the update resource is stored in the mobile device memory during an initialization of the mobile device, prompting a mobile device user to select one of the baseline mobile device configuration or updated mobile device configuration; and
accepting the updated mobile device configuration or reverting to the baseline mobile device configuration based on the user selection.

10. The method of claim 1, wherein determining whether the mobile device has associated update resources to meet the resource requirements comprises determining whether the mobile device has a minimum amount of computational resources to execute update computations on stored mobile device data stored in the mobile device memory to create updated mobile device data.

11. The method of claim 10, wherein allocating update resources to the mobile device if the mobile device does not have associated update resources to meet the resource requirements comprises:
upon determining that the mobile device does not have the minimum amount of computational resources, identifying stored mobile device data stored in the mobile device memory for which update computations are to be executed; and
transmitting the identified stored mobile device data to the update management computing device for execution of the update computations to create the updated mobile device data; and
purging the identified stored mobile device data from the mobile device memory.

12. The method of claim 11, further comprising:
updating the mobile device with the received update data;
transmitting a request from the mobile device to the update management computing device for transmission of the updated mobile device data from the update management computing device to the mobile device;
receiving the updated mobile device data from the update management computing device in response to the transmitted request; and
storing the updated stored mobile device data in the mobile device memory.

13. The method of claim 1, wherein updating the mobile device with the received update data comprises:
determining a baseline mobile device configuration;
creating an updated mobile device configuration within the available memory of the mobile device; and
maintaining the baseline mobile device configuration after creating the updated mobile device configuration within the available memory of the mobile device.

14. The method of claim 13, wherein updating the mobile device with the received update data further comprises:
determining whether to accept the updated mobile device configuration;
upon determining to accept the updated mobile device configuration, accepting the updated mobile device configuration as the mobile device baseline; and
upon determining not to accept the updated mobile device configuration, reverting to the baseline mobile device configuration.

15. The method of claim 13, wherein updating the mobile device with the received update data further comprises:
storing an update resource in the mobile device memory, the update resource specifying the baseline mobile device configuration and updated mobile device configuration;
determining whether an update resource is stored in the mobile device memory during an initialization of the mobile device;
upon determining that the update resource is stored in the mobile device memory during an initialization of the mobile device, prompting a mobile device user to select one of the baseline mobile device configuration or updated mobile device configuration; and
accepting the updated mobile device configuration or reverting to the baseline mobile device configuration based on the user selection.

16. The method of claim 13, wherein updating the mobile device with the received update data further comprises copy-on-write of stored baseline configuration data stored into the available memory of the mobile device.

17. Executable program code stored in a computer readable medium and comprising instructions operable to cause a mobile device to perform the method of claim 1 when executed on the mobile device.

18. A method of updating a mobile device, comprising:
transmitting from an update management computing device to a mobile device resource requirements data for an update;
receiving at the update management computing device an update request transmitted from the mobile device in response to the transmitted resource requirements data; and
transmitting from the update management computing device to the mobile device the update data in response to the update request.

19. The method of claim 18, further comprising:
receiving stored mobile device data transmitted from the mobile device;
storing the stored mobile device data in the update management computing device;
receiving a stored mobile device data request transmitted from the mobile device; and
transmitting from the update management computing device to the mobile device the stored mobile device data.

20. The method of claim 18, further comprising:
receiving stored mobile device data transmitted from the mobile device;
storing the stored mobile device data in the update management computing device; and
execution update computations to create updated mobile device data in the update management computing device.

21. The method of claim 20, further comprising:
receiving an updated mobile device data request transmitted from the mobile device; and
transmitting from the update management computing device to the mobile device the updated mobile device data.

22. The method of claim 20, further comprising:
receiving a stored mobile device data request transmitted from the mobile device; and
transmitting from the update management computing device to the mobile device the stored mobile device data.

23. Executable program code stored in a computer readable medium and comprising instructions operable to cause a computer device to perform the method of claim 18 when executed on the computer device.

24. A system for updating a mobile device over a communication network, comprising:
a mobile communication device comprising a processing subsystem, a memory subsystem, and a communication subsystem, the processing subsystem coupled to the memory subsystem and communication subsystem and operable to store and retrieve data in the memory subsystem, to execute instructions stored in the memory subsystem, and to cause the communication subsystem to transmit and receive data over the communication network; and
mobile device update management and allocation program code comprising instructions executable by the processing subsystem and stored in the memory subsystem, the instructions operable to cause the processing subsystem to receive resource requirements data for an update transmitted over the communication network, determine whether the mobile device has associated update resources to meet the resource requirements, allocate update resources in the mobile device if the mobile device does not have associated update resources to meet the resource requirements, and transmit over the communication network update request data requesting update data from an update management computing device.

25. The system of claim 24, wherein the mobile device update management and allocation program code comprises further instructions executable by the processing subsystem and stored in the memory subsystem, the further instructions operable to cause the processing subsystem to determine whether the mobile device has a minimum amount of available memory in the mobile device memory subsystem, and upon determining that the mobile device does not have the minimum amount of available memory, identify stored mobile device data stored in the memory subsystem that may be purged to make available the minimum amount of available memory.

26. The system of claim 25, wherein the mobile device update management and allocation program code comprises further instructions executable by the processing subsystem and stored in the memory subsystem, the further instructions operable to cause the processing subsystem to determine whether the identified stored mobile device data is stored on a remote storage device operable to communicate with the mobile device over a communication network, and upon determining that the identified stored mobile device data is not stored on the remote storage device, transmit the identified stored mobile device data to the remote storage device for storage and purge the identified stored mobile device data from the mobile device memory after the transmission.

27. The system of claim 26, wherein the mobile device update management and allocation program code comprises further instructions executable by the processing subsystem and stored in the memory subsystem, the further instructions operable to cause the processing subsystem to update the mobile device with the received update data, transmit a request to the remote storage device for transmission of the identified stored mobile device data from the remote storage device to the mobile device, receive identified stored mobile device data from the remote storage device in response to the transmitted request, and store the identified stored mobile device data in the mobile device memory subsystem.

28. The system of claim 27, wherein the mobile device update management and allocation program code comprises further instructions executable by the processing subsystem and stored in the memory subsystem, the further instructions operable to cause the processing subsystem to determine a baseline mobile device configuration, create an updated mobile device configuration within the available memory of the memory subsystem, and maintain the baseline mobile device configuration after creating the updated mobile device configuration within the available memory of the memory subsystem.

29. The system of claim 28, wherein the mobile device update management and allocation program code comprises further instructions executable by the processing subsystem and stored in the memory subsystem, the further instructions operable to cause the processing subsystem to determine whether to accept the updated mobile device configuration, and upon determining to accept the updated mobile device configuration, accept the updated mobile device configuration as the mobile device baseline, and upon determining not to accept the updated mobile device configuration, revert to the baseline mobile device configuration.

30. The system of claim 29, wherein the mobile device update management and allocation program code comprises further instructions executable by the processing subsystem and stored in the memory subsystem, the further instructions operable to cause the processing subsystem to store an update resource in the mobile device memory subsystem, the update resource specifying the baseline mobile device configuration and updated mobile device configuration, determine whether an update resource is stored in the mobile device memory during an initialization of the mobile device, upon determining that the update resource is stored in the mobile device memory subsystem during an initialization of the mobile device, prompt a mobile device user to select one of the baseline mobile device configuration or the updated mobile device configuration, and accept the updated mobile device configuration or revert to the baseline mobile device configuration based on the user selection.

31. The system of claim 24, wherein the mobile device update management and allocation program code comprises further instructions executable by the processing subsystem and stored in the memory subsystem, the further instructions operable to cause the processing subsystem to determine whether the mobile device has a minimum amount of computational resources to execute update computations on stored mobile device data stored in the mobile device memory subsystem to create updated mobile device data, and upon determining that the mobile device does not have the minimum amount of computational resources, identify stored mobile device data stored in the mobile device memory subsystem for which update computations are to be executed, and transmit the identified stored mobile device data to the update management computing device for execution of the update computations to create the updated mobile device data.

32. The system of claim 31, wherein the mobile device update management and allocation program code comprises further instructions executable by the processing subsystem and stored in the memory subsystem, the further instructions operable to cause the processing subsystem to update the mobile device with the received update data, transmit a request to the update management computing device for transmission of the updated mobile device data from the update management computing device to the mobile device, receive the updated mobile device data from the update management computing device in response to the transmitted request, and store the updated mobile device data in the mobile device memory subsystem.

33. The system of claim 24, wherein the mobile device update management and allocation program code comprises further instructions executable by the processing subsystem and stored in the memory subsystem, the further instructions operable to cause the processing subsystem to determine a baseline mobile device configuration, create an updated mobile device configuration within the available memory of the memory subsystem, and maintain the baseline mobile device configuration after creating the updated mobile device configuration within the available memory of the memory subsystem.

34. The system of claim 33, wherein the mobile device update management and allocation program code comprises further instructions executable by the processing subsystem and stored in the memory subsystem, the further instructions operable to cause the processing subsystem to determine whether to accept the updated mobile device configuration, and upon determining to accept the updated mobile device configuration, accept the updated mobile device configuration as the mobile device baseline, and upon determining not to accept the updated mobile device configuration, revert to the baseline mobile device configuration.

35. The system of claim 34, wherein the mobile device update management and allocation program code comprises further instructions executable by the processing subsystem and stored in the memory subsystem, the further instructions operable to cause the processing subsystem to store an update resource in the mobile device memory subsystem, the update resource specifying the baseline mobile device configuration and updated mobile device configuration, determine whether an update resource is stored in the mobile device memory during an initialization of the mobile device, upon determining that the update resource is stored in the mobile device memory subsystem during an initialization of the mobile device, prompt a mobile device user to select one of the baseline mobile device configuration or the updated mobile device configuration, and accept the updated mobile device configuration or revert to the baseline mobile device configuration based on the user selection.

36. A system for updating a mobile device over a communication network, comprising:
an update management server comprising a processing subsystem, a memory subsystem, and a communication subsystem, the processing subsystem coupled to the memory subsystem and communication subsystem and operable to store and retrieve data in the memory subsystem, to execute instructions stored in the memory subsystem, and to cause the communication subsystem to transmit and receive data over the communication network; and
update server management and allocation program code comprising instructions executable by the processing subsystem and stored in the memory subsystem, the instructions operable to cause the processing subsystem to transmit resource requirements data for an update to a mobile device over the communication network, receive update request data transmitted from a mobile device over the communication network in response to the transmitted resource requirements data, and transmit update data back to a mobile device over the communication system in response to the update request data.

37. The system of claim 36, wherein the update server management and allocation program code comprises further instructions executable by the processing subsystem and stored in the memory subsystem, the further instructions operable to cause the processing subsystem to receive stored mobile device data transmitted from a mobile device, store the stored mobile device data in the memory subsystem, receive a stored mobile device data request transmitted from a mobile device, and transmit to a mobile device the stored mobile device data.

38. The system of claim 37, wherein the update server management and allocation program code comprises further instructions executable by the processing subsystem and stored in the memory subsystem, the further instructions operable to cause the processing subsystem to receive stored mobile device data transmitted from a mobile device, store the stored mobile device data in the memory subsystem, and execute update computations to create updated mobile device data.

39. The system of claim 38, wherein the update server management and allocation program code comprises further instructions executable by the processing subsystem and stored in the memory subsystem, the further instructions operable to cause the processing subsystem to receive an updated mobile device data request transmitted from a mobile device, and transmit from the updated mobile device data to a mobile device.

40. The system of claim 37, wherein the update server management and allocation program code comprises further instructions executable by the processing subsystem and stored in the memory subsystem, the further instructions operable to cause the processing subsystem to receive a stored mobile device data request transmitted from a mobile device and transmit the stored mobile device data to a mobile device.

41. The system of claim 36, further comprising:
a mobile communication device comprising a processing subsystem, a memory subsystem, and a communication subsystem, the processing subsystem coupled to the memory subsystem and communication subsystem and operable to store and retrieve data in the memory subsystem, to execute instructions stored in the memory subsystem, and to cause the communication subsystem to transmit and receive data over the communication network; and
mobile device update management and allocation program code comprising instructions executable by the processing subsystem and stored in the memory subsystem, the instructions operable to cause the processing subsystem to receive resource requirements data for an update transmitted over the communication network from update management server, determine whether the mobile device has associated update resources to meet the resource requirements, allocate update resources in the mobile device if the mobile device does not have associated update resources to meet the resource requirements, and transmit over the communication network the update request data requesting update data from the update management server.

42. A system for updating a mobile device, comprising:
means for receiving at a mobile device resource requirements data for an update;
means for determining whether the mobile device has associated update resources to meet the resource requirements;
means for allocating update resources to the mobile device if the mobile device does not have associated update resources to meet the resource requirements;
means for transmitting from the mobile device update request data requesting update data; and
means for receiving at the mobile device the update data in response to the transmitted update request data.

43. The system of claim 42, further comprising:
means for transmitting from to a mobile device the resource requirements data for an update;
means for receiving the update request transmitted from the mobile device in response to the transmitted resource requirements data; and
means for transmitting from to the mobile device the update data in response to the update request.

44. A mobile communication device, comprising:
a processing subsystem, a memory subsystem, and a communication subsystem, the processing subsystem coupled to the memory subsystem and communication subsystem and operable to store and retrieve data in the memory subsystem, to execute instructions stored in the memory subsystem, and to cause the communication subsystem to transmit and receive data over a communication network; and
executable update management and allocation program code stored in the memory subsystem and comprising instructions operable to cause the mobile device to perform the method of claim 1 when executed by the processing subsystem.

45. A mobile communication device, comprising:
a processing subsystem, a memory subsystem, and a communication subsystem, the processing subsystem coupled to the memory subsystem and communication subsystem and operable to store and retrieve data in the memory subsystem, to execute instructions stored in the memory subsystem, and to cause the communication subsystem to transmit and receive data over a communication network; and
executable update management and allocation program code stored in the memory subsystem and comprising instructions operable to cause the mobile device to receive memory requirements data for an update transmitted over the communication network, determine whether the mobile device has associated memory resources to meet the memory requirements, allocate memory resources in the mobile device if the mobile device does not have associated memory resources to meet the memory requirements, and transmit over the communication network update request data requesting update data from an update management computing device upon determining that associated memory resources may be allocated.

46. The mobile device of claim 45, wherein the update management and allocation program code comprises further instructions that cause the mobile device to identify stored mobile device data stored in the mobile device memory that may be purged to make available the memory resources, determine whether the identified stored mobile device data is stored on a remote storage device operable to communicate with the mobile device over the communication network, and upon determining that the identified stored mobile device data is not stored on the remote storage device, transmit the identified stored mobile device data to the remote storage device for storage and purging the identified stored mobile device data from the mobile device memory subsystem.

47. The mobile device of claim 46, wherein the update management and allocation program code comprises further instructions that cause the mobile device to update the mobile device with update data received in response to the update data request, transmit a request from the mobile device to the remote storage device for transmission of the identified stored mobile device data from the remote storage device to the mobile device, receive the identified stored mobile device data from the remote storage device in response to the transmitted request, and store the identified stored mobile device data in the mobile device memory.
